(19) United States
(12) Patent Application Publication
(10) Pub. No.: US 2010/0157020 A1
(43) Pub. Date: Jun. 24, 2010

(54) MULTIPLE CAMERA CONTROLLING AND IMAGE STORING APPARATUS FOR SYNCHRONIZED MULTIPLE IMAGE ACQUISITION AND METHOD THEREOF

(75) Inventors: Yoon-Seok CHOI, Daejeon (KR); Jeung Chul PARK, Daejeon (KR); Chang Woo CHU, Daejeon (KR); Ji Hyung Lee, Daejeon (KR); Jin Seo KIM, Daejeon (KR); Seung Wook LEE, Daejeon (KR); Ho Won KIM, Daejeon (KR); Bon Woo HWANG, Daejeon (KR); Bon Ki KOO, Daejeon (KR); Gil haeng LEE, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/571,854

(22) Filed: Oct. 1, 2009

(30) Foreign Application Priority Data
Dec. 22, 2008 (KR) 10-2008-0131664

(51) Int. Cl. H04N 5/232; H04N 13/04

(52) U.S. Cl. 348/47; 348/211.11; 348/211.3; 348/E05.042; 348/E13.074

(57) ABSTRACT

The invention provides a camera controlling and image storing apparatus for synchronized multiple image acquisition and method thereof, which cut down equipment costs by taking a software approach with respect to various demands of viewers for a broadcasting image. A camera controlling and image storing apparatus, the apparatus includes an image acquiring unit for acquiring synchronized images from multiple cameras losslessly, one or more ingest agents for storing the acquired images, and controlling pan, tilt and zoom operations of the cameras based on the acquired images, and a central server for transmitting a control command to the ingest agents, and receiving and integrating collectively the stored images of the ingets agent.

### CROSS-REFERENCE(S) TO RELATED APPLICATIONS

The present invention claims priority of Korean Patent Application No. 10-2008-0131664, filed on Dec. 22, 2008, which is incorporated herein by reference.

### FIELD OF THE INVENTION

The present invention relates to a camera controlling and image storing apparatus for synchronized multiple image acquisition and method thereof, and more particularly, to a synchronized real-time multi-point image managing apparatus and method, which control one or more HD cameras to acquire synchronized images, store them in real time losslessly, and control operations of each camera such as pan, tilt and zoom.

### BACKGROUND OF THE INVENTION

With development of an image processing technology, a conventional 2D multimedia service has evolved into an image-based 3D realistic service. Particularly, a broadcasting technology field has accomplished a lot of progresses based on various camera technologies so as to vividly transfer reality of the site. Recently, with fusion of broadcasting and communication, studies have been made to develop a broadcasting-communication fusion type full 3D restoration technology.

The conventional camera technologies include a slow motion camera which captures a fine motion of a target, a rail camera which follows an object rapidly moving in a space by rails, and a crane camera mounted on the end of a crane arm to effectively capture a motion of a target in different views. Image engineers of a broadcasting station capture dynamic and vivid images using such technologies. However, it becomes more difficult to satisfy various increasing demands of viewers with a hardware camera such as an ultrahigh speed camera, slow motion camera, rail camera and crane camera.

A sports broadcasting relay field of broadcasting contents requires more various technologies so as to vividly transfer motions of players running in a stadium to viewers. As a solution, one or more cameras are installed in various angles for photographing. Then, multiple synchronized images are acquired, selectively combined, and provided to the viewers, such that the viewers feel like they move in the stadium and watch an instantaneous highlight scene in the best seat.

In the related art, in order to implement 360 degrees turning image or capture an object stopped in mid-air, an image collecting apparatus, which uses a motion camera or several cameras, is utilized to acquire images and generate a desirable effect of the images by equipment control using a switch or the like. For this operation, it is necessary to have a lot of equipments such as a digital control unit (DCU), a master setup unit (MSU), a digital multiplex equipment (DME), a digital video switcher (DVS) and a digital video tape recorder (DVTR). However, such equipments are high-priced and restricted in installation and movement, and functions that can be implemented as hardware in the camera and the control equipment are limited to color change, caption insertion and the like.

Consequently, attempts have been continuously made to control a camera more easily and provide an image with various effects through the combination of the multiple synchronized image acquiring technology and the computer-based image processing technology.

### SUMMARY OF THE INVENTION

It is, therefore, an object of the present invention to provide a camera controlling and image storing apparatus for synchronized multiple image acquisition and method thereof, which cut down equipment costs by taking a software approach with respect to various demands of viewers for a broadcasting image.

Another object of the present invention is to provide a camera controlling and image storing apparatus for synchronized multiple image acquisition and method thereof, which control multiple HD cameras in real time with respect to an object and store images, by supporting a synchronized control command to the HD cameras.

In accordance with a first aspect of the present invention, there is provided a camera controlling and image storing apparatus, the apparatus includes an image acquiring unit for acquiring synchronized images from multiple HD cameras losslessly, one or more ingest agents for storing the acquired images, and controlling pan, tilt and zoom operations of the cameras based on the acquired images, and a central server for transmitting a control command to the ingest agents, and receiving and integrating collectively the stored images of the ingest agents.

It is preferable that each of the ingest agents includes an image processing unit for analyzing position information of the cameras and computing camera operation settings based on the acquired images in response to the control command, an image storage unit for synchronizing the acquired images and storing the synchronized images losslessly, and an operation control unit for controlling the pan, tilt and zoom operations of the cameras depending on the camera operation settings.

It is preferable that the image processing unit includes a camera operation setting computing unit for analyzing the position information of the cameras and computing the camera operation settings based on the acquired images in response to the control command, a geometry correcting unit for analyzing the position information of the cameras from the images, a color correcting unit for correcting colors of the images, a foreground/background segmentation unit for separating a foreground and a background of the images, and an image transmitting unit for the result images

It is preferable that the image processing unit computes the camera operation settings by using at least one of a method for allowing each of the ingest agents to independently perform object tracking, and a method for performing a space search so that an object to be photographed can maintain a specific size in a screen center.

It is preferable that the image storage units are allocated to the multiple cameras one to one to perform real-time lossless storing.

It is preferable that the apparatus further includes a dual network unit composed of a control network for synchronizing and transmitting the control command between the ingest agents and the central server, and a data network for transmitting the stored data.

It is preferable that the control network is an RS-422 based network, and the data network is an Ethernet based network.

It is preferable that the image acquiring units are connected to the two multiple cameras, respectively, to acquire HD images in real time losslessly.

It is preferable that each of the ingest agents uses a delayed synchronous command including a time code, and executes the control command after a delay equivalent to a time designated in the time code, upon receipt of the control command.

It is preferable that each of the ingest agents encapsulates its overall images and selects ingest agents to perform simultaneous transmission, and the selected ingest agents parallel-transmit the encapsulated images to the central server in block units via multiple hubs.

In accordance with a second aspect of the present invention, there is provided a camera controlling and image storing method, the method includes acquiring synchronized images from multiple cameras losslessly, analyzing position information of the cameras to compute camera operation settings based on the acquired images, controlling the pan, tilt and zoom operations of the cameras based on the camera operation settings, and synchronizing the acquired images and storing the synchronized images losslessly.

It is preferable that the method further includes receiving a control command, and computing the camera operation settings in response to the control command.

It is preferable that the control command includes one of a passive control command for allowing the central server to designate the camera operation settings and an active control command for allowing each of the cameras to compute and use the camera operation settings.

It is preferable that the method further includes correcting colors of the images, and separating a foreground and a background of the images.

It is preferable that said analyzing position information of the cameras to compute camera operation settings uses at least one of a method for independently performing object tracking, and a method for performing a space search so that an object to be photographed can maintain a specific size in a screen center.

It is preferable that the control command and the stored images are transmitted through separated networks.

It is preferable that the method further includes using a delayed synchronous command including a time code to execute the control command after a delay equivalent to a time designated in the time code, upon receipt of the control command.

It is preferable that the acquired images are real time lossless HD images received from the two multiple cameras.

It is preferable that the method further includes encapsulating overall images, selecting one or more camera control units to perform simultaneous transmission, and parallel-transmitting, at the selected camera control units, the encapsulated images in block units via multiple hubs.

It is preferable that the method further includes extracting image frames, processing the image frames, and encapsulating the processed image frames in frame units and transmitting the encapsulated image frames.

### BRIEF DESCRIPTION OF THE DRAWINGS

The above and other objects and features of the present invention will become apparent from the following description of preferred embodiments, given in conjunction with the accompanying drawings, in which:

FIG. 1, is a block diagram illustrating a structure of a camera controlling and image storing apparatus in accordance with the present invention;

FIG. 2 is a block diagram illustrating an inner structure of the image processing unit;

FIG. 3 illustrates a process in which each ingest agent independently performs an object tracking;

FIGS. 4A and 4B illustrate a process in which the ingest agents uses a space search technique;

FIG. 5 is a flowchart illustrating a camera controlling and image storing method in accordance with the present invention;

FIG. 6 is a flowchart illustrating a delayed synchronous command technique;

FIG. 7 is a flowchart illustrating a process of overall image transmission;

FIG. 8 is a flowchart illustrating a process of frame-unit image transmission; and

FIG. 9 illustrates a process of parallel-transmitting multiple HD image data stored in ingest agents to a processed image storage unit of a central server using multiple hubs.

### DETAILED DESCRIPTION OF THE EMBODIMENTS

Hereinafter, embodiments of the present invention will be explained in detail with reference to the accompanying drawings. In the following description, well-known functions or constitutions will not be described in detail if they would obscure the invention in unnecessary detail. Further, the terminologies to be described below are defined in consideration of functions in the present invention and may vary depending on a user's or operator's intention or practice. Thus, the definitions should be understood based on all the contents of the specification.

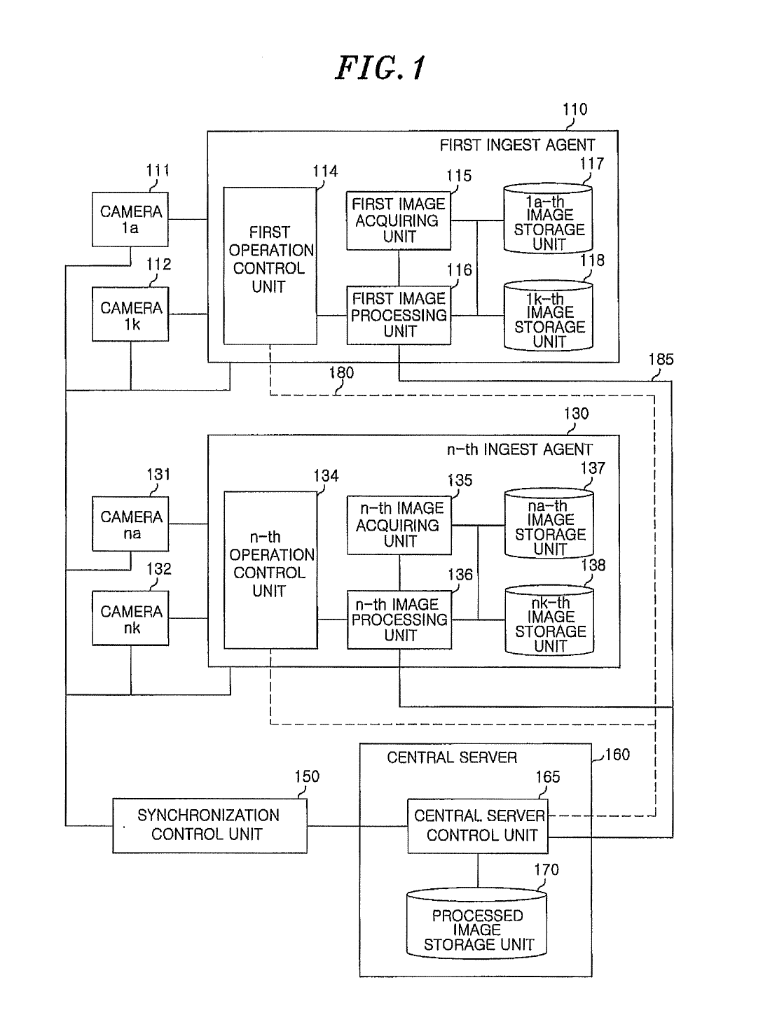

FIG. 1 is a block diagram illustrating a structure of a camera controlling and image storing apparatus in accordance with the present invention.

In this embodiment, a camera 1a 111 to a camera 1k 112 are connected to a first ingest agent 110, and a camera na 131 to a camera nk 132 are connected to an n-th ingest agent 130, to acquire HD images, respectively. The ingest agents 110 and 130 perform automatic geometric/color correction of the cameras, and synchronize, store and process the images transferred from the cameras in real time losslessly. The ingest agent 110 includes an image acquiring unit 115 for acquiring multiple real-time synchronized images, an image processing unit 116 for computing camera operation settings from the acquired images, and performing other image processing, image storage units 117 and 118 for storing the acquired or processed image data, and an operation control unit 114 for controlling operations of the multiple cameras 111 and 112 such as pan, tilt and zoom based on the camera operation settings computed by the ingest agent 110 or a control command transferred from a central server 160.

The central server 160 actively or passively controls operations of the cameras 111, 112, 131 and 132 and the ingest agents 110 and 130, and creates various camera effect images. The active control means that the operations of the multiple cameras 111, 112, 131 and 132 connected thereto such as the pan, tilt and zoom is controlled based on the acquired images from the respective ingest agents 110 and 130. The passive control means that the central server 160 designates and transmits pan, tilt and zoom values of the respective multiple cameras 111, 112, 131 and 132. The central server 160 can be comprised of a central server control unit 165 for processing transmission/reception of control commands and image data and synchronization with the ingest agents 110 and 130, and a processed image storage unit 170 for integrating and storing image data transmitted from the respective ingest agents 110 and 130.

In this embodiment, two HD cameras 111 and 112 are connected to one ingest agent 110. Alternatively, as far as an image storing apparatus can store real-time lossless synchronized images, k HD cameras can be connected to one ingest agent 110. If the ingest agent and the camera are connected one to one, the system is too large to be managed. Therefore, the central server 160 remotely controls k-number of HD cameras and k/2 ingest agents, to collectively manage image acquisition and reproduction, data management, camera operation control and so on. As a result, high-priced equipments such as a broadcasting studio camera, DCU, DME, MSU, DVS and DVTR are replaced by a computer system and network, thereby providing a cheaper and more scalable system.

Also, in this embodiment, HD images inputted from the respective cameras 111 and 112 are stored in the image storage units 117 and 118 in real time losslessly via the image acquiring unit 115, wherein the cameras correspond to the storage units one to one. The image storage units 117 and 118 can be implemented with physically-separated image storing apparatuses. An image board can be employed to acquire HD images from the multiple cameras. If a few images are simultaneously stored in one storing medium, since physical fragmentation may occur degrading performance of the image storing apparatus, the images of the cameras are made to correspond to the storing media one to one. The image storage units 117 and 118, which are the storing media of this embodiment, can support storage performance over 250 MB/s to process an HD image at 1.48 GB/s without a loss.

Alternatively, dual networks may be adopted, which are composed of separated networks, i.e., a control network 180 where the central server 160 transfers a control command to the cameras 111, 112, 131 and 132 and the ingest agents 110 and 130, and a data network 185 where the ingest agents 110 and 130 transmit large image data to the central server 160. The reason for using the physically-separated dual networks is to prevent or reduce a command transfer delays resulting from network traffic overload by large data transmission in a single network. To be more specific, an RS-422 based serial communication network can be used as the control network 180, and an Ethernet based network can be used as the data network 185. Since the RS-422 based serial communication network ensures command transfer within 12 ms, when the pan, tilt and zoom of the cameras 111, 112, 131 and 132 are controlled to track a rapidly-moving object, it is possible to acquire 60 image frames per sec.

Alternatively, a synchronization control unit 150 may be further included to generate a synchronous signal to the overall system.

The central server 160 synchronizes the overall system through the use of the synchronization control unit 150 or a delayed synchronous command, and transmits a control command relating to the image acquisition of the cameras 111, 112, 131 and 132 or the camera operation settings such as the pan, tilt and zoom over the control network 180. The ingest agents 110 and 130 interpret and execute the transmitted control command, such that the images acquired from the cameras 111, 112, 131 and 132 are stored in the image storage units 117, 118, 137 and 138 in real time, respectively. The stored images undergo an image processing operation such as geometry/color correction and foreground/background segmentation in the image processing units 116 and 136 of the ingest agents 110 and 130 in units of the respective cameras 111, 112, 131 and 132, are transferred to the central server 160 through the data network 185, and stored in the processed image storage unit 170. The operation of the image processing units 116 and 136 in the ingest agents 110 and 130 will be described below in more detail.

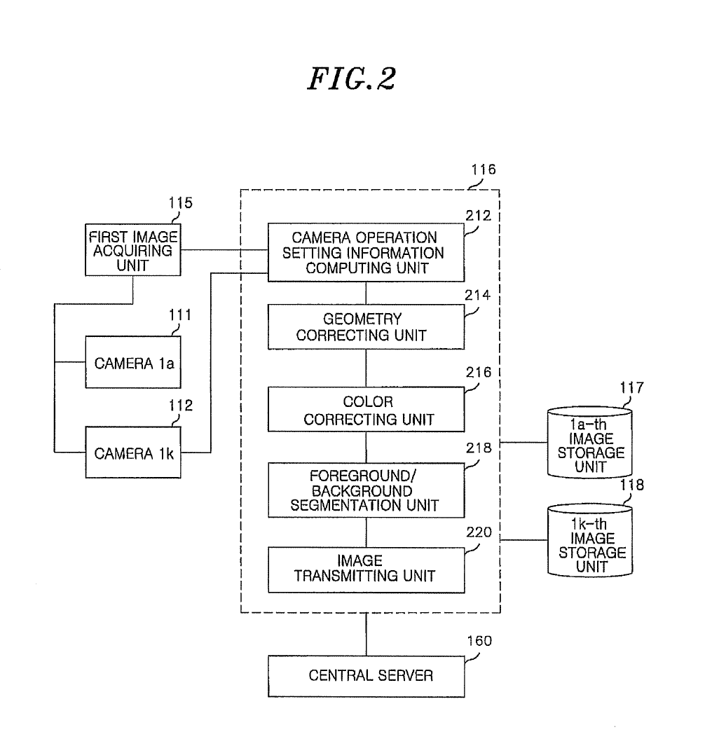

FIG. 2 is a block diagram illustrating an inner structure of the image processing unit.

In this embodiment, the image processing unit 116 includes a camera operation settings computing unit 212 for computing the camera operation settings from the images transferred from the image acquiring unit 115 connected to the cameras 111 and 112, a geometry correcting unit 214 for analyzing camera position information from the acquired images, a color correcting unit 216 for correcting colors of the multiple camera images, a foreground/background segmentation unit 218 for separating a foreground and background from the acquired images or corrected images, and an image transmitting unit 220 for storing the processed images in the image storage units 117 and 118 or outputting them to the central server 160.

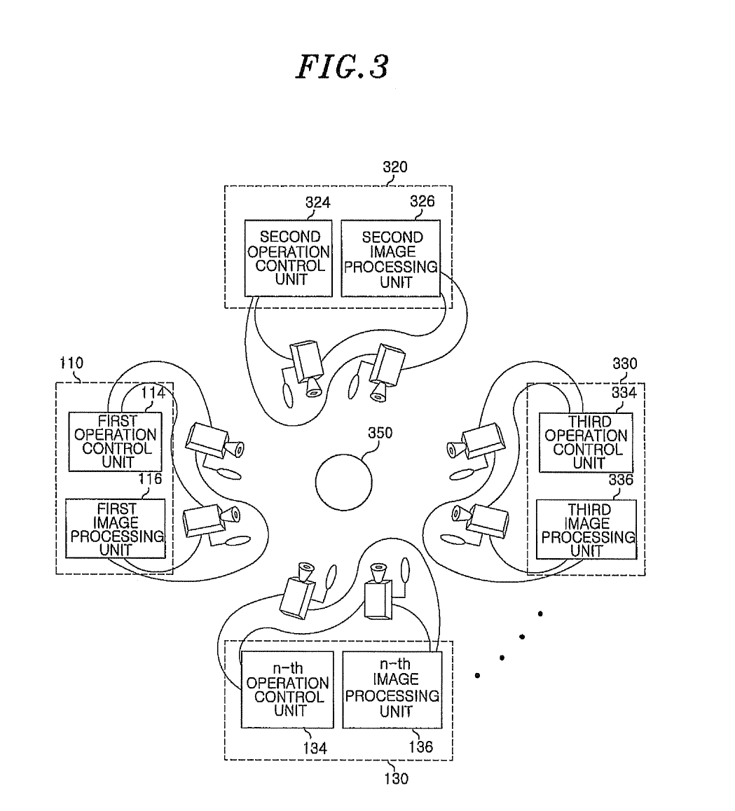

FIG. 3 illustrates a process in which each ingest agent independently performs an object tracking.

This process corresponds to the active control of the multiple cameras by the ingest agent as described above. In this embodiment, respective ingest agents 110, 320, 330 and 130 employ an active multiple camera control method, such that respective cameras independently track an object 350. The respective ingest agents 110, 320, 330 and 130 perform an automatic geometric correction for automatically setting values of camera operation settings such as pan, tilt and zoom, using an object tracking technique.

The values of the operation setting of the multiple cameras can be set by the passive control as well as the active control. In this case, the operations of each multiple camera such as the pan, tilt and zoom are controlled by values directly inputted from a central server 160 (not shown).

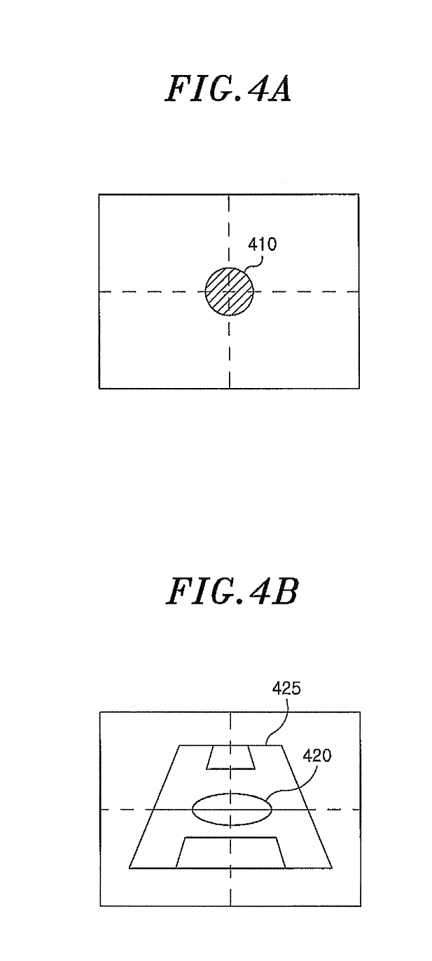

FIGS. 4A and 4B illustrates a process in which each ingest agent uses a space searching technique.

FIG. 4A shows a case where motions of cameras are restricted. For example, an object such as a red ball 410 is put in a specific position of a small space such as a studio or stage, and photographed by each camera. Each ingest agent automatically sets values of pan, tilt and zoom using the space searching technique, such that the red ball 410 maintains a diameter of e.g., 10 pixels in a screen center.

FIG. 4B shows a soccer stadium 425, wherein in a space like a sports stadium, values of pan, tilt and zoom are automatically set using previously-drawn space objects such as a central line, a penalty area and a center circle 420 or a trackable object such as a soccer ball. In this case, each ingest agent automatically sets the values of the pan, tilt and zoom using the space search technique, such that an up-down direction diameter of an ellipse where the center circle 420 is displayed on a screen maintains e.g., a diameter of 10 pixels. Here, when the method for actively controlling the respective cameras using the real-time tracking function of the ingest agent is used, instead of a conventional master/slave tracking technique controlled by a master behavior, it is possible to reduce a delay caused by a command transfer.

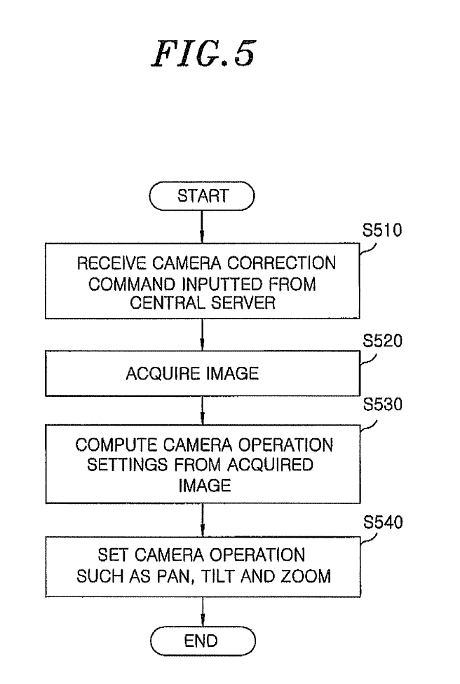

FIG. 5 is a flowchart illustrating an active camera controlling and image storing method in accordance with the present invention.

First of all, a process of acquiring an image from a camera and storing the image will be explained. When an operator observes an analog image transmitted from the camera and requests the central server to perform encoding, the camera which received an encoding command captures an image. The image processing unit in the ingest agent stores the acquired image from camera in the image storage unit in the ingest agent. Thereafter, upon receipt of a quit-encoding command from the central server, the camera quits encoding and the image processing unit ends storing. The image stored in the image storage unit is transferred to the central server through the data network, and stored in the processed image storage unit which is a large-capacity storage.

Next, a process performed by the ingest agent for automatic correction is as follows. First, the ingest agent receives a camera automatic correction command inputted from the central server in step S510, and then acquires a image from the camera in response to the command in step S520. Subsequently, the image processing unit in the ingest agent computes camera operation settings from the acquired image in step S530, and the operation control unit in the ingest agent sets camera operations such as pan, tilt and zoom based on the computed information in step S540.

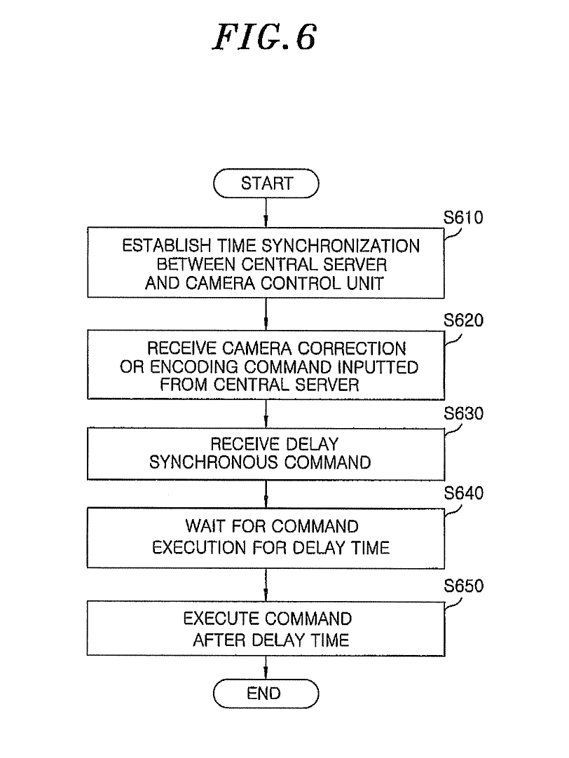

FIG. 6 is a flowchart illustrating a delayed synchronous command technique.

In this embodiment, since it is necessary to rapidly collect a lot of images at 60 fps depending on a broadcasting environment such as a sports relay broadcasting, operation control of pan, tilt and zoom of a camera and synchronization in image acquisition are important. When the central server transfers a camera operation control command or an image acquisition command to the ingest agents, if the command reaches each ingest agent in a different time due to a system delay, operations of the cameras are not synchronized. In order to solve the foregoing problem, this embodiment uses the delayed synchronous command technique, a process of which is as follows.

First of all, the central server and the ingest agents perform time synchronization through mutual time code transmission in step S610. Then, the central server transmits an image encoding command or a camera correction command in step S620, wherein, at this time, the central server designates a delayed synchronous command. The delayed synchronous command is a control command including a time code. The command reaching each ingest agent is not executed instantly but executed after a designated delay time, e.g. a few ms of delay. The delay time value is a difference value for time synchronization between each ingest agent and the central server, and determined through time code synchronization between the central server and each ingest agent. The ingest agents receive the delayed synchronous command transmitted from the central server in step S630, interpret it, and await for the delay time in step S640. After the delay time elapses, the respective ingest agents execute the command at the same time in step S650.

Meanwhile, aside from the delayed synchronous command, a synchronization control unit may be added to achieve synchronization. The synchronization control unit can be implemented with a trigger or time generator in hardware. The synchronization control unit generates a synchronous signal, and periodically transmits it to the cameras and the ingest agents, thereby establishing synchronization between the respective cameras. When the central server transmits an encoding command to the ingest agent, the ingest agent receives it and sends an encoding start command to the cameras. The image processing unit that is implemented with an image capture board compares synchronous signals of the cameras with a synchronous signal of the image processing unit, and synchronizes and stores images inputted from the cameras. When the central server requests an encoding quit, the ingest agent ends encoding of the cameras and transfers the stored image to the central server.

The image transmission from the ingest agents to the central server is performed in two image transfer modes: overall image transmission and frame image transmission.

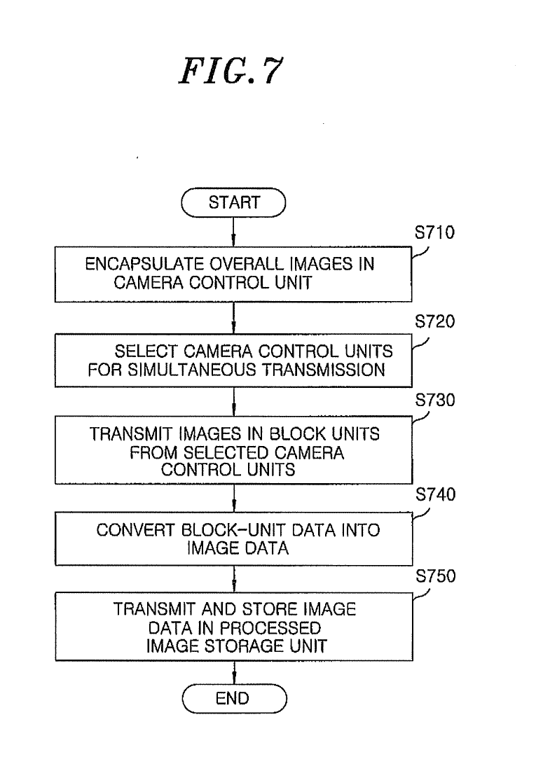

FIG. 7 is a flowchart illustrating a process of the overall image transmission.

Since the overall image transmission is to transfer the overall images, it causes a severe network load. When all the ingest agents execute transmission, a transmission delay occurs due to the network overload. Therefore, a distribution transmission method using m hubs is employed. k ingest agents selected to use shared hubs are connected to allocated hubs, respectively, to transmit m images equivalent to the number of the hubs to the central server at a time, thereby minimizing the network overload.

First of all, the respective ingest agents encapsulate the overall stored images in step S710 and select k ingest agents to perform simultaneous transmission in step S720. The selected k ingest agents transmit the encapsulated image data through the shared hubs in large data block units in step S730. The central server converts them back into image data in step S740, and transmits the image data to the processed image storage unit to store it therein in step S750. In this case, in order to prevent a storage delay and storage fragmentation caused by hardware sharing, the processed image storage unit can be comprised of m physically separated disk storages which are equivalent to the number of the hubs.

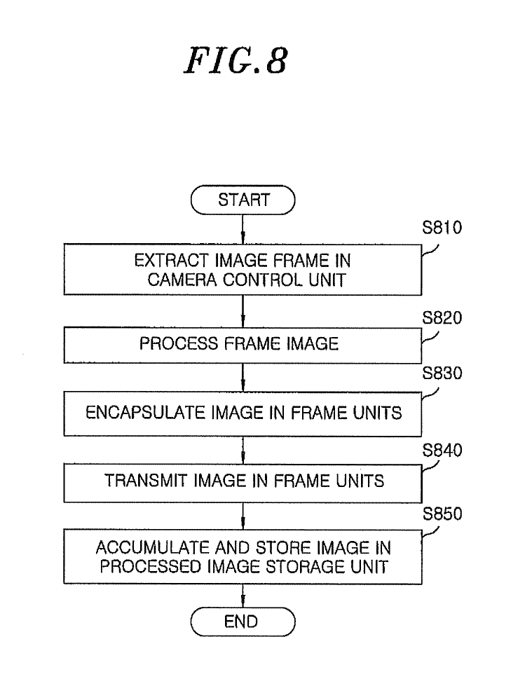

FIG. 8 is a flowchart illustrating a process of the frame-unit image transmission.

The frame image transmission can be carried out when the ingest agent needs to perform an image processing operation on a frame. When the central server requests target frames to the ingest agents, each ingest agent extracts corresponding image frames from each camera in step S810. Thereafter, the ingest agents perform an image processing operation such as geometry correction, color correction and foreground/background separation on each extracted frame in step S820, encapsulate an original frame image and a processed image in step S830, and transmit the images to the central server by frame in step S840. Lastly, the central server accumulates the images by frames, and stores them in the processed image storage unit in step S850.

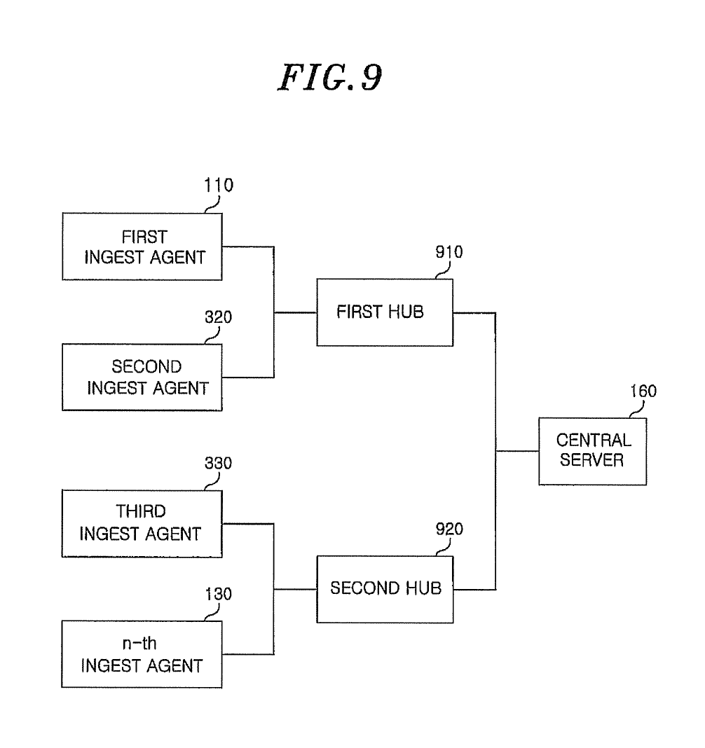

FIG. 9 illustrates a process of parallel-transmitting multiple image data stored in ingest agents to a processed image storage unit of a central server via multiple hubs.

This embodiment suggests a process of acquiring video images from multiple HD cameras, and storing them in a processed image storage unit 170 which is a large-capacity storing medium of a central server 160. First and second ingest agents 110 and 320 are connected to a first hub 910, and third and n-th ingest agents 330 and 130 are connected to a second hub 920. The respective ingest agents 110, 320, 330 and 130 encapsulate image data and transmit them to the hubs 910 and 920, and the respective hubs 910 and 920 parallel-transmit the image data to the central server 160, thereby improving transmission efficiency.

The modules, functional blocks or means used in these embodiments may be implemented with a variety of publicly-known devices, such as electronic circuits, integrated circuits, and application specific integrated circuits (ASICs). Also, they may be implemented separately, or two or more of them may be implemented integrally.

Further, the technology of the present invention may also be applied to pictures and images that can be displayed on a display such as an LCD, instead of characters.

In accordance with the present invention, since various functions such as camera control, image acquisition and synchronization are carried out in a software type, the system is simplified, the upgrade is facilitated, and the image processing such as foreground/background separation, color correction and geometry correction can be easily performed.

In addition, the multiple images acquired and synchronized by the present invention can be used for stereoscopic TV or three-dimensional model reconstruction, thereby improving a contents application of a next-generation TV environment.

While the invention has been shown and described with respect to the embodiments, it will be understood by those skilled in the art that various changes and modification may be made.

What is claimed is:

1. A camera controlling and image storing apparatus, the apparatus comprising:
an image acquiring unit for acquiring synchronized images from multiple HD cameras losslessly;
one or more ingest agents for storing the acquired images, and controlling pan, tilt and zoom operations of the cameras based on the acquired images; and
a central server for transmitting a control command to the ingest agents, and receiving and integrating collectively the stored images of the ingest agents.

2. The apparatus of claim 1, wherein each of the ingest agents includes:
an image processing unit for analyzing position information of the cameras and computing camera operation settings based on the acquired images in response to the control command;
an image storage unit for synchronizing the acquired images and storing the synchronized images losslessly; and
an operation control unit for controlling the pan, tilt and zoom operations of the cameras depending on the camera operation settings.

3. The apparatus of claim 2, wherein the image processing unit includes:
a camera operation setting computing unit for analyzing the position information of the cameras and computing the camera operation settings based on the acquired images in response to the control command;
a geometry correcting unit for analyzing the position information of the cameras from the images;
a color correcting unit for correcting colors of the images;
a foreground/background segmentation unit for separating a foreground and a background of the images; and
an image transmitting unit for the result images.

4. The apparatus of claim 2, wherein the image processing unit computes the camera operation settings by using at least one of a method for allowing each of the ingest agents to independently perform object tracking, and a method for performing a space search so that an object to be photographed can maintain a specific size in a screen center.

5. The apparatus of claim 2, wherein the image storage units are allocated to the multiple cameras one to one to perform real-time lossless storing.

6. The apparatus of claim 1, further comprising:
a dual network unit composed of a control network for synchronizing and transmitting the control command between the ingest agents and the central server, and a data network for transmitting the stored data.

7. The apparatus of claim 6, wherein the control network is an RS-422 based network, and the data network is an Ethernet based network.

8. The apparatus of claim 1, wherein the image acquiring units are connected to the two multiple cameras, respectively, to acquire HD images in real time losslessly.

9. The apparatus of claim 1, wherein each of the ingest agents uses a delayed synchronous command including a time code, and executes the control command after a delay equivalent to a time designated in the time code, upon receipt of the control command.

10. The apparatus of claim 1, wherein each of the ingest agents encapsulates its overall images and selects ingest agents to perform simultaneous transmission, and the selected ingest agents parallel-transmit the encapsulated images to the central server in block units via multiple hubs.

11. A camera controlling and image storing method, the method comprising:
acquiring synchronized images from multiple cameras losslessly;
analyzing position information of the cameras to compute camera operation settings based on the acquired images;
controlling the pan, tilt and zoom operations of the cameras based on the camera operation settings; and
synchronizing the acquired images and storing the synchronized images losslessly.

12. The method of claim 11, further comprising:
receiving a control command; and
computing the camera operation settings in response to the control command.

13. The method of claim 12, wherein the control command includes one of a passive control command for allowing the central server to designate the camera operation settings and an active control command for allowing each of the cameras to compute and use the camera operation settings.

14. The method of claim 11, further comprising:
correcting colors of the images; and
separating a foreground and a background of the images.

15. The method of claim 11, wherein said analyzing position information of the cameras to compute camera operation settings uses at least one of a method for independently performing object tracking, and a method for performing a space search so that an object to be photographed can maintain a specific size in a screen center.

16. The method of claim 12, wherein the control command and the image data are transmitted through separated networks.

17. The method of claim 12, further comprising:
using a delayed synchronous command including a time code to execute the control command after a delay equivalent to a time designated in the time code, upon receipt of the control command.

18. The method of claim 11, wherein the acquired images are real time lossless HD images received from the two multiple cameras.

19. The method of claim 11, further comprising:
encapsulating overall images;
selecting one or more camera control units to perform simultaneous transmission; and
parallel-transmitting, at the selected camera control units, the encapsulated images in block units via multiple hubs.

20. The method of claim 11, further comprising:
extracting image frames;
processing the image frames; and
encapsulating the processed image frames in frame units and transmitting the encapsulated image frames.
